(19) United States
(12) Patent Application Publication
(10) Pub. No.: US 2006/0259534 A1
(43) Pub. Date: Nov. 16, 2006

(54) Data distribution method and device

(76) Inventors: Moritaka Kimura, Tokyo (JP); Junichi Nakajima, Tokyo (JP); Tetsuro Kondo, Tokyo (JP)

Correspondence Address: Richard L Sampson;Samson & Associate, Suite 510, 50 Congress Street, Boston, MA, 02109, US

(21) Appl. No.: 10/561,872

(22) PCT Filed: Jun. 11, 2004
(86) PCT No.: PCT/JP04/08230

§ 371 Date: May 30, 2006

(30) Foreign Application Priority Data
Jun. 23, 2003 (JP) 2003-178321

(51) Int. Cl. G06F 17/15

(52) U.S. Cl. 708/422

(57) ABSTRACT

Computers PC of n stations, each equipped with a storage device to accommodate the data to be cross-correlated, are connected to a line concentrator or communications network that has a switching function. The data allocated to each computer can be divided into n or more partial data, and each partial data is assigned to perform the cross correlation operation to each computer. Furthermore, in PC's connected in such a manner that data can be transmitted via a line concentrator or communication network, mutually between 2 PC's connected each other, the step of transmiting partial data from the PC to the partner PC connected to the PC is repeated. Thereby, it is possible to effectively distribute data as an object of the cross correlation operation stored in multiple storage devices of PC's to each PC.

### TECHNICAL FIELD

The present invention relates to the method and device that distributes data from multiple computer storage devices to the computer required to make the computations. This device is especially designed for data as an object of cross correlation operation.

### BACKGROUND OF THE INVENTION

Presently, computing machines are used to process cross-correlation operations in a wide array of fields ranging from observational analysis of radio frequency interference such as VLBI (Very Long Baseline Interference) etc., to signal analysis in the telecommunications system, analysis of seismic waves, analysis of electro cardiograms electromyograms brain waves etc., the analysis of weather data, and the vibration analysis for construction projects.

Computers are typically used to carry out cross-correlation operations. If the amount of cross-correlated data needed to be processed is relatively small, general purpose computers on the market today are capable of efficiently processing the cross-correlated data for high performance of the general purpose computer in recent years.

Although there is no set definition of what a general purpose computer is, it may be assumed that it includes a computer that is capable of batch processing, real-time processing, online processing and other functions determined by its programming. To put it in another perspective, a general purpose computer consists of a processor and main storage device that co-operate with each other when linked together, and is equipped with a control circuit that performs operations in accordance with prescribed directions. A personal computer is an example of a general purpose computer.

On the opposite side of the spectrum are specialized computers, which like general purpose computers have no set definition. For the most part specialized computers are often designed to perform specific tasks such as image processing and cross-correlation processing at a highly efficient level. To put it in another perspective, an example would be a computer with arithmetic processing hardware which is in charge of processing prescribed directions related to its function.

When there is a relatively large amount of cross-correlated data to be processed, a general purpose computer would have to devote a large amount of resources to processing this data, which could yield results such as a sharp drop in operating speed. It is in these situations where a specialized computer is often used in processing cross-correlated data.

We will now examine a concrete example using VLBI. VLBI is a type of interferometry in which radio wave which is a radio source from the universe acquired by multiple VLBI channel radio telescopes are received and recorded. Waves from common radio sources from the universe (analog signal) are recorded on magnetic tape after being converted to a digital signal using the atomic frequency standard. These tapes are then transported to a location where a correlation device is available, and the digital signals from contained on all of the tapes are synchronized and played back together. The correlator is then used to calculate the correlation function between these digital signals. In recent years the need to physically transport magnetic tapes to a location with a correlator has been superseded by the increased transmission speed of network cables. This has resulted in the direct transmission of data from the converted digital signals to the correlator. That is to say that the digitally converted data from each VLBI channel is not recorded to magnetic tape, but is transmitted directly to the correlator using communications equipment via a cable. In this manner real time cross-correlation processing has now been realized. Although we have summarized the aspects of VLBI relevant to our invention, in practice things are not so simple.

The correlator mentioned previously is equivalent to a specialized computer. As the data to be recorded from the digital signals observed from the VLBI reach up to 1 gigabit per second, the load on a single general purpose computer performing the cross-correlation processing would be too heavy. Instead a specialized computer, in this case a correlator, is used to process the data.

As indicated, the use of a specialized computer to perform cross-correlation processing is presently quite typical. But an enormous amount of effort and cost is expended on developing these specialized computers.

It is for this reason that we took notice of the increasingly efficient and powerful general purpose computer. By developing an array of general purpose computers to perform the cross-correlation processing, we feel that we can realize cross-correlation processing on a level comparable with specialized computers. The use of a single specialized computer to process the correlation of an enormous amount of data, as previously mentioned, would result in a severe slowing down of the execution, and the pressure placed on the bus used to read data from the storage device would be too great, resulting in crashes or other major problems.

If an array of general purpose computers where employed to perform the cross-correlation processing, the problem would not be the amount of data, but rather the manner in how to arrange the array of general purpose computers to handle the cross-correlating of the data.

Naturally, when data is being stored on a storage device attached to a single general purpose computer, there will be no significant problems in distributing this data to other computers. However, when data recorded on storage devices attached to an array of general purpose computers, a highly efficient system of distributing this data is required.

### DISCLOSURE OF THE INVENTION

### Problem to be Solved by the Invention

Taking the above into consideration, an object of the present invention is to provide both a method and a device which can efficiently distribute data to be cross correlated that is recorded on storage devices attached to an array of computers.

### MEANS FOR SOLVING THE PROBLEM

The following methods are used in the distribution of data to resolve the problems outlined above. In the network system that computers PC0, PC1, PC2, . . . , PCn−2, PCn−1 (where i is an integer from 0 to n−1 and is expressed in the term PCi) of n stations (where n is a natural number of 2 and more) are connected to a line concentrator or communications network that has a switching function, the data distribution method is characterized in that each computer each computer PC0, PC1, PC2, . . . , PCn−2, and PCn−1 has a storage device that is responsible for storing data X0, X1, X2, . . . , Xn−2, Xn−1 (where i is an integerre from 0 to n−1 and represents the number of Xi) that is to be cross correlated, the data Xi noted above on each PCi can be divided into n or more partial data Xi(0), Xi(1), Xi(2), . . . , Xi(n−2), Xi(n−1) (where j is an integer from 0 to n−1 and represents the number of Xi(j)), computer PCk (k is an integer from 0 to n−1) is is responsible for the cross correlation processing of partial data Xi(k) located on each computer PCi and further, in each pair including 2 computers which are connected to be able transmit data via the line concentrator or communications network noted above, mutually between 2 computers which are connected, the computer repeats steps that computers transmit their allocated partial data to the partner computer which is connected to said computer between each other.

For the above mentioned step, if n is an even number, then it will be repeated n−1 times, and if n is an odd number, it will be repeated n times. At the same time, same computers are allocated to each pair of the above without overlapping in each step and the same pair is allocated without overlapping through all of the steps for repetition between the pair. In this manner the most efficient method of transmitting data can be achieved.

Furthermore, providing that a line concentrator capable of full duplex transmission is used, In the network system that n (n is any real number of 2) number of computers PCi, (integer i represents the number of PCi from 0 to n−1) are connected to a line concentrator or communications network capable of full duplex transmission with switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(j) (j is an integer from 0 to n−1), computer PCk (k is an integer from 0 to n−1) is responsible for the cross correlation processing of partial data Xi(k) located on each computer PCi, and further, in computers which are connected to be able transmit data via the line concentrator or communications network noted above, in repeating the step that computers transmit their allocated partial data between the computer which sends data and the computer which receives data, during each step, same computer for sending and same computer for receiving are allocated without overlapping and same computers are allocated without overlapping through all of the steps, and these steps are repeated n−1 times, regardless of whether n being even or odd, which results in all computers PCi exchanging data simultaneously, resulting in a highly efficient transmission that is improved by not being limited by the even or odd value of n.

Or, in the network system that n (n is any real number of 2) number of computers PCi, (integer i represents the number of PCi from 0 to n−1) are connected to a line concentrator or communications network that has a switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(m) (m is an integer from 0 to n−1) having a size of unit data and can be divided into the block of every consecutive n of the partial data without overlapping, computer PCk (k is an integer from 0 to n−1) is responsible for the cross correlation processing of partial data Xi(k) located on each computer PCi, and further, in each pair including 2 computers which are connected to be able transmit data via the line concentrator or communications network noted above, mutually between 2 computers which are connected, the computer repeats steps that computers transmit their allocated partial data to the partner computer which is connected to said computer between each other.

The above mentioned block α (where α is an integer greater than 0) includes partial data from (n×α) to (n×α+n−1), and computer PCk is responsible for the cross-correlation of partial data Xi (k+n×α) from each computer PCi. As an example, if the data are time series data which are collected from the observation such as an experiment, the time-marched chronological data are distributed in sequential order (block by block) with doing data collection, and on the other cross correlation processing can be performed.

For each of the above-mentioned blocks, and for the above mentioned step, if n is an even number then it is repeated n−1 times, and if n is an odd number it is repeated n times. At the same time, same computers are allocated to each pair without overlapping in each step and the same pair is allocated without overlapping through all of the steps for repetition between the pair. In this manner the most efficient method of transmitting data can be achieved.

Once again, providing that a line concentrator capable of full duplex transmission is used, In the network system that n (n is any real number of 2) number of computers PCi, (integer i represents the number of PCi from 0 to n−1) are connected to a line concentrator or communications network capable of full duplex transmission with switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(m) (m is an integer from 0 to n−1) having a size of unit data and can be divided into the block of every consecutive n of the partial data without overlapping, computer PCk (k is an integer from 0 to n−1) is responsible for the cross correlation processing of partial data Xi(k) located on each computer PCi, and further, in computers which are connected to be able transmit data via the line concentrator or communications network noted above, in repeating the step that computers transmit their allocated partial data between the computer which sends data and the computer which receives data, during each step, same computer for sending and same computer for receiving are allocated without overlapping and same computers are allocated without overlapping through all of the steps, and these steps are repeated n−1 times, regardless of whether n being even or odd, which results in all computers PCi exchanging data simultaneously, resulting in a highly efficient transmission that is improved by not being limited by the even or odd value of n.

Of particular note is that despite the fact that a general purpose computer is being used as opposed to an expensive specialized computer, a level of cross correlation processing comparable with a specialized computer is attained.

Since the network medium is capable of full duplex transmission, data transmission between the computers of 2 stations connected to be capable of transmitting data are transmitted at the almost same time, thereby reducing the amount of time required to distribute the data.

When the said data is observed in chronological order by a radio telescope, similar to the previously given VLBI example, the amount of data to be recorded per unit time is enormous. Therefore, by applying this invention's data distribution method of processing data, the efficiency of cross-correlating the data enables it to be distributed to each station.

In the network system that n (n is any real number of 2) number of computers PCi, (integer i represents the number of PCi from 0 to n−1) are connected to a line concentrator or communications network that has a switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(j) (j is an integer from 0 to n−1), computer PCk (k is an integer from 0 to n−1) is responsible for the cross correlation processing of partial data Xi(k) located on each computer PCi and further, in each pair including 2 computers which are connected to be able to transmit data via the line concentrator or communications network noted above, mutually between 2 computers which are connected, includes data transmission means which repeats steps that computers transmit their allocated partial data to the partner computer which is connected to said computer between each other.

Or, in the network system that n (n is any real number of 2) number of computers PCi, (integer i represents the number of PCi from 0 to n−1) are connected to a line concentrator or communications network that has a switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(j) (j is an integer from 0 to n−1), computer PCk (k is an integer from 0 to n−1) is responsible for the cross correlation processing of partial data Xi(k) located on each computer PCi and further, in each pair including 2 computers which are connected to be able to transmit data via the line concentrator or communications network noted above, mutually between 2 computers which are connected, includes data transmission means which repeats steps that computers transmit their allocated partial data to the partner computer which is connected to said computer between each other.

Once again, providing that a line concentrator capable of full duplex transmission is used, In the network system that n (n is any real number of 2) number of computers PCi, (integer i represents the number of PCi from 0 to n−1) are connected to a line concentrator or communications network capable of full duplex transmission with switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(j) (j is an integer from 0 to n−1), computer PCk (k is an integer from 0 to n−1) is responsible for the cross correlation processing of partial data Xi(k) located on each computer PCi, and further, in computers which are connected to be able transmit data via the line concentrator or communications network noted above, in repeating the step that computers transmit their allocated partial data between the computer which sends data and the computer which receives data, during each step, same computer for sending and same computer for receiving are allocated without overlapping and same computers are allocated without overlapping through all of the steps, and includes data transmission means in which these steps are repeated n−1 times, regardless of whether n being even or odd,

In a similar fashion, providing that a line concentrator capable of full duplex transmission is used, In the network system that n (n is any real number of 2) number of computers PCi, (integer i represents the number of PCi from 0 to n−1) are connected to a line concentrator or communications network capable of full duplex transmission with switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(m) (m is an integer from 0 to n−1) having a size of unit data and can be divided into the block of every consecutive n of the partial data without overlapping, computer PCk (k is an integer from 0 to n−1) is responsible for the cross correlation processing of partial data Xi(k) located on each computer PCi, and further, in computers which are connected to be able transmit data via the line concentrator or communications network noted above, in repeating the step that computers transmit their allocated partial data between the computer which sends data and the computer which receives data, during each step, same computer for sending and same computer for receiving are allocated without overlapping and same computers are allocated without overlapping through all of the steps, and data transmission means in which these steps are repeated n−1 times, regardless of whether n being even or odd,

The data distribution may be formed by the network medium being capable of full duplex transmission. A reduction in time for organizing and processing the data can be achieved.

### ADVANTAGEOUS EFFECT OF THE INVENTION

Even when dealing with a large-scale amount of data such as those found in the time series data received from radio telescopes when making VLBI observations, this data distribution method and device is capable of dividing data to be cross-correlated from storage devices connected to computers of multiple stations into partial data which is transmitted to the computers responsible for the cross-correlation of the data. Through this highly efficient distribution method, expensive specialized computers are avoided and cheaper general purpose computers cross-correlate the data through distributed processing. Furthermore, the transmission time for each step in the process for this data distribution method and device is not affected by whatever number of n stations there are. Finally, as illustrated in equation 1 and 2, operations can be completed after either n cycles or n−1 cycles.

Also, data is divided into partial data of greater than n as the size of the unit data and the consecutive units of partial data are segmented into blocks without overlapping. As data is being arranged in every each block, the distribution of the data already collected to each station is capable with doing data collection, and therefore cross-correlation processing of the already collected data can be achieved with the data collection, almost at the same time.

Especially since the network medium or the line concentrator is capable of full duplex transmission, a reduction in time for distribution of the data can be achieved.

### BRIEF DESCRIPTION OF THE DRAWINGS

FIG. 1 is a schematic block diagram showing a network configuration of an exemplary embodiment according to the present invention.

FIG. 2 is a schematic block diagram showing a configuration of PC of an exemplary embodiment according to the present invention.

FIG. 3 illustrates the before and after arrangement of data with this invention for the recording of partial data on the external storage devices of each PC for n units partial data.

FIG. 4 illustrates the before and after arrangement of data with this invention for the recording of partial data on the external storage devices of each PC for units of partial data greater than n.

FIG. 5 illustrates the steps involved with exchanging data using a full duplex transmission capable line concentrator for an odd number PC stations.

### EXPLANATION OF NUMERICAL REFERENCE

1 PC
2 switching hub
3 cable

### BEST MODE OF CARRYING OUT THE INVENTION

Although the preferred embodiment of this invention will be explained using the accompanying figures, the embodiment of this invention is not limited to the following examples. The embodiment can be altered in a suitable manner which does not deviate from the primary purpose of this invention.

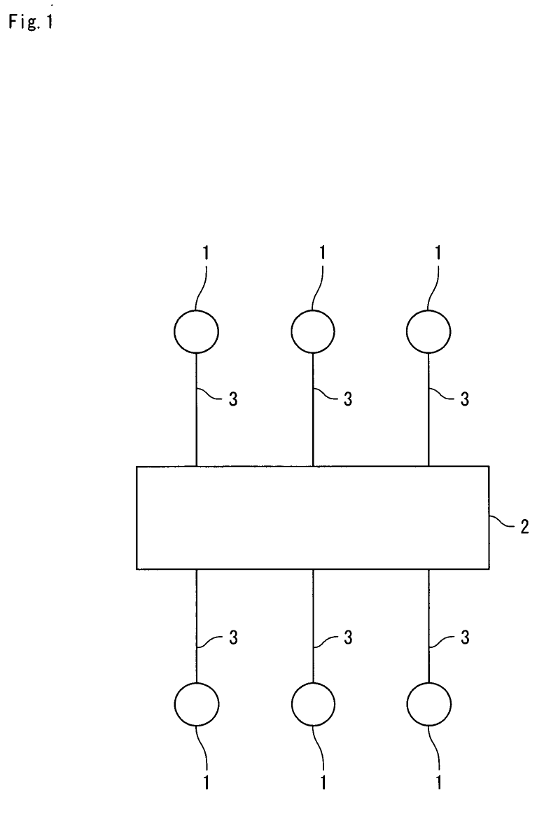

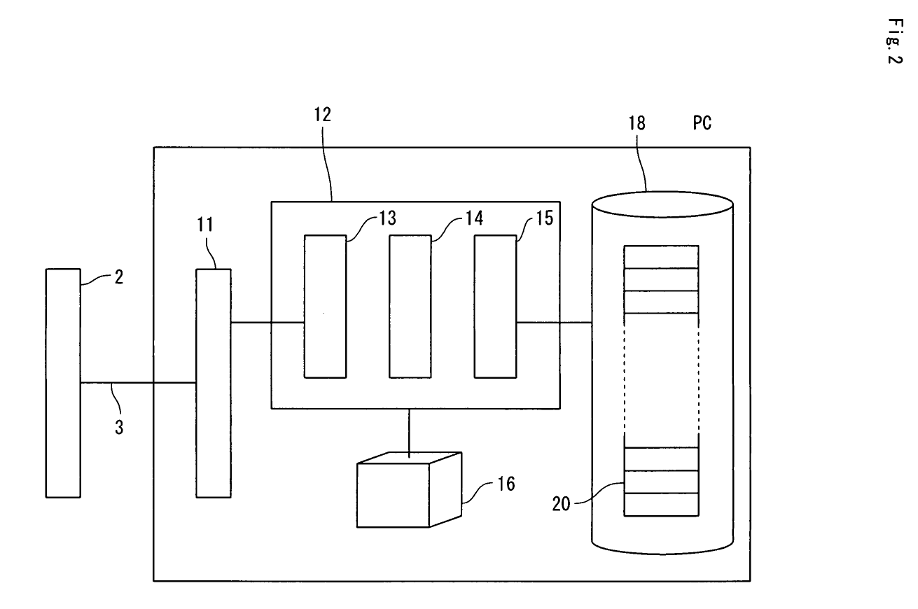

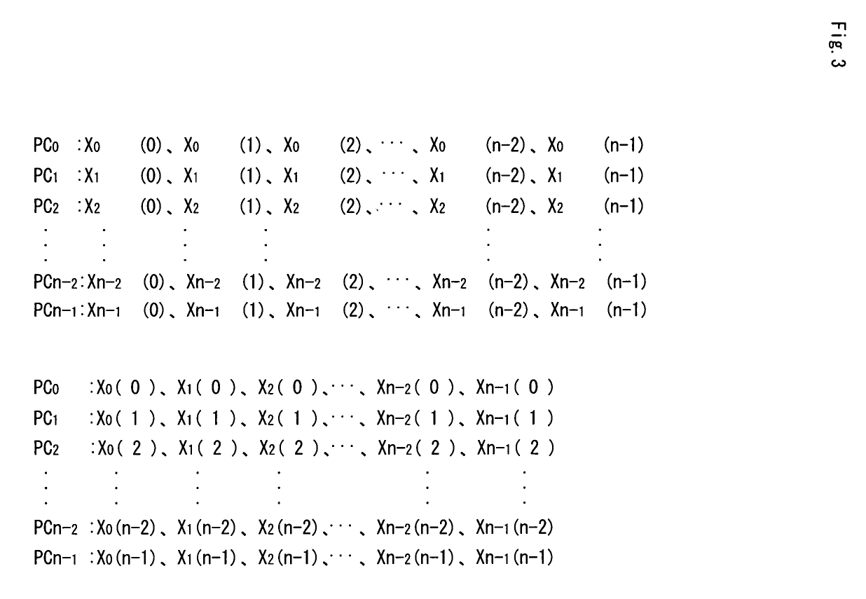

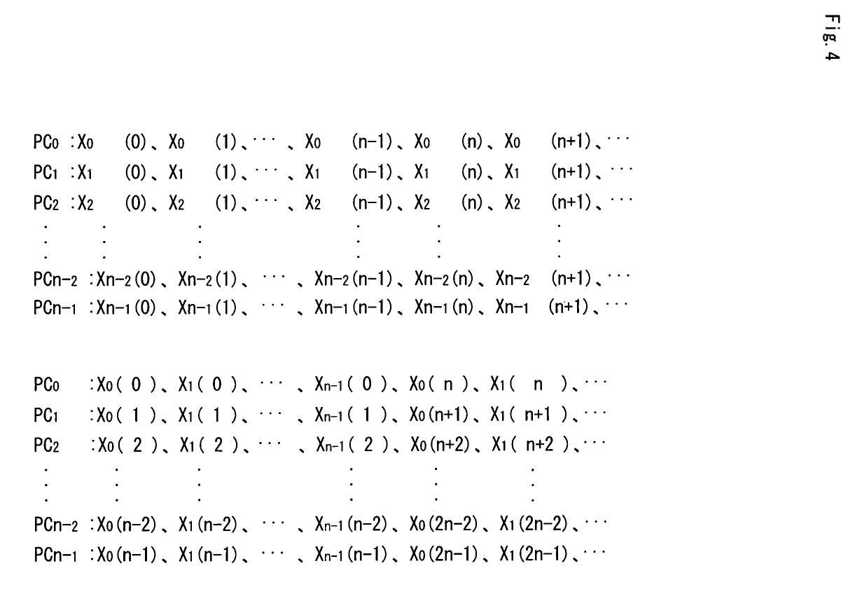

FIG. 1 illustrates an example network configuration for this invention. FIG. 2 illustrates an example configuration of PCs. FIG. 3 illustrates the before and after arrangement of data with this invention for the recording of partial data on the external storage devices of each PC for n units partial data. FIG. 4 illustrates the before and after arrangement of data with this invention for the recording of partial data on the external storage devices of each PC for units of partial data greater than n.

In the exemplary embodiment, a computing machine is a general purpose computer, a personal computer for example (henceforth referred to as PC). However, the methods employed by this invention are not only limited to general purpose computers, and can in fact also be used by specialized computers.

In the exemplary embodiment, there are n (where n is a natural number greater than 2) stations of PCs 1. In other words, there are multiple PC stations. A subscript is applied when referencing the PC in order to describe each PC beginning with PC0, PC1, PC2, . . . , PCn−2, PCn−1. Furthermore, PCi using of the subscript i, which is an integer from 0 to n−1, can also be used to represent the same meaning providing there are no special restrictions. To avoid any complicated symbols in FIG. 1, symbols have not been used for identification purposes.

It is not necessary for each PCi 1 to have the exact same device configuration and performance. However, since each PCi 1 will be performing cross-correlation processing, machines capable of performing at a suitable level is desired.

Each PCi 1 is connected via a network cable 3 to a switching function enabled line concentrator, or switching hub 2. (See FIG. 1)

In FIG. 1, n=6, that is to say 6 PC stations 1 are displayed.

The network cable 3 is a bidirectional full duplex transmission capable cable which has the communication speed of 2 times. This full duplex transmission capable cable is ideal for connecting 2 PC stations together and allowing mutual transfer of data. One example of such a cable is an Ethernet (Ethernet: registered trademark) twisted pair cable. Another example may be an optical fiber cable. The higher the transmission speed of the cable 3, the better. For example, in the previously mentioned VLBI example, the amount of data being transferred can reach 1 gigabyte of data a second. Therefore, to reduce the amount of time required to transfer the data a high transmission speed is desired. For the above-mentioned Ethernet (registered trademark), gigabit Ethernet (registered trademark) is an example of a communications speed that can attain 1 Gbps (GBit/second).

And the cable 3 is not limited to being a full duplex transmission capable medium. For example, a half duplex cable which splits the sending and receiving of data may also be used. In the case where a half duplex transmission cable is used, 2 PC stations, PC2 and PC5 for example, must take turns transferring data. For instance PC2 send to PC5, and then PC5 to PC2. However, a full duplex transmission cable will be able to simultaneously transmit data from PC2 to PC5, and vice-versa. Therefore the large difference with using a half duplex transmission cable as compared to a full duplex transmission cable is that the amount of time required to complete the transmission of data will be almost double.

The switching hub 2 is a hub with switching functions. The physical addresses of the Ethernet (registered trademark) devices connected to the hub's ports are stored in memory. The switching hub 2 uses them when establishing a direct connection to transmit data between paired ports. Even with transmissions between multiple PCs 1, data collisions are avoided.

PCi 1 of n stations are connected to the switching hub 2 via a cable 3 in a network configuration. This type of network configuration (topology) is known as a star configuration. As PCi 1 of n stations can be considered each segment, the switching hub 2 can be said as a pulti-port repeater, because the switching hub 2 acts as a relay for each of the segments.

Although we have described multiple PC's 1 connected by cables 3 to a switching hub 2 in a star configuration, other embodiment involving multiple PC's 1 connected to a communications network, such as configuration also connected to the internet, are possible. In this situation, since data is mutually transmitted between multiple PC's as described below, it is important to avoid sharing part or all of the communication line when transmitting data between multiple PC's in order to prevent data collisions. Furthermore, when transmitting a relatively large amount of data, a suitable amount of bandwidth on the communication line is desired.

In addition, concerning the case where the communication speed varies according to the performance of the existing internet or other telecommunication network connection, it would be normal for the optimal line speed to differ according to the particular setup of the employed network, thus a high-speed connection is recommended to attain optimal communication speeds.

Each PCi is equipped with a storage device. In general this storage device consists of the external storage device referred to as the hard disk 18. The data 20 stored on this external storage device 18 is what will be cross-correlated. The data 20 stored on the external storage device 18 of PC0 is X0, while the data 20 on the external storage device 18 of PC1 is X1, the other PCs in the configurations are set up identically to PCi with the data 20 contained on their external storage devices 18 listed to as Xi.

Furthermore, each PCi 1 is equipped with a central processing unit 12, a main storage device 16, and the transmission part 11 which transfer data 20 stored in the external storage device 18 connected to the cable 3 to the other PCs. The central processing unit 12 include the data controller 15 which control the data 20 stored on the external storage device 18, the operation part 14 which processes crss correlation operation, and the transmission control part 13 which controls the toransmission part 11.(referring to FIG. 2) It is not included in the figure, but it is worth noting that the external storage device 18 stores the program responsible for controlling the order and type of data transfers with the other PCs. In addition, the data 20 stored on the external storage device 18 can be transferred to other PCs through the transmission part 11 as instructed by the internal data controlier 15 in the central processing unit 12.

Each data Xi is divisible by n. In other words, X0 is divided into partial data X0(0), X0(1), X0(2), . . . , X0(n−2), X0(n−1). X1 is divided into partial data X1(0), X1(1), X1(2), . . . , X1(n−2), X1(n−1). Similarly, Xi can be divided into partial data Xi(0), Xi(1), Xi(2), . . . , Xi(n−2), Xi(n−1) n times. In this manner the data Xi(j) stored on the external storage device 18 of PCi 1 and divided into n units of partial data can also be expressed as data Xi (j). Here, j represents an integer from 0 to n−1.

Although we use the term “divisible” here, the “division” that occurs through the operation of this invention yields consecutive data Xi divided into data Xi(j) as seen in the above-mentioned formula. Furthermore, bear in mind that there will be cases where data Xi results in the sum of partial data Xi . . . of which it is comprised.

Using the time siries data from VLBI observations as a concrete example, the analog signal data from the radio telescope are converted to match those set by the atomic frequency standard for suitability, and then recorded to the external storage device 18. It must be granted as previously mentioned that the resulting data through VLBI sampling is impractical to calculate due to its complexity, in which case this invention can demonstrate its relevance. For example, the data 20 recorded to this external storage device 18 can be lumped together in 1 section of 4 seconds, or it can be recorded in 4 sections of 1 second each. If there were 4 stations for the radio telescope, that is to say 4 PC stations, the former case could see the 4 seconds of data partitioned into 4 sections of 1 second each; 0 sec to 1 sec, 1 sec to 2 sec, 2 sec to 3 sec, and 3 sec to 4 sec. In the latter case on the other hand, the data is already stored in 4 separate sections of 1 second each, yet since 4 seconds of data are stored in 1 second sections this case would also be considered as “divisible”.

This data distribution method is currently quite well known and may be used for partitioning in application software.

There is no requirement that size of each unit of partial data Xi(j) must match the others. However, for the most part it is ideal if they do. In other words, data Xi should be resulted in equal units when divided n times. As for this embodiment, providing that there are no special circumstances, the data should be equally divisible by n.

As described above, each PCi 1 is responsible for the cross-correlation operations its partial data. Specifically, as for PC0, it is responsible for cross-correlating the data of the 0th cycle of partial data Xo(0) in PC0, 0th cycle of partial data X1(0) in PC1, 0th cycle of partial data X2(0) in PC2, . . . , 0th cycle of partial data Xn−2(0) in PCn−2, and 0th cycle of partial data Xn−1(0) in PCn−1. In other words, PC0 takes charge of the 0th part of data i(0) for all computers PCi 1, allowing for the cross-correlation of data.

Identical to above, PC1 is responsible for cross-correlating the data of the 1st cycle of partial data Xo(1) in PC0, 1st cycle of partial data X1(1) in PC1, 1st cycle of partial data X2(1) in PC2, . . . , 1st cycle of partial data Xn−2(1) in PCn−2, and the 1st cycle of partial data Xn−1(1) in PCn−1. In other words, PC1 takes charge of the 1st part of data Xi(1) for all computers PCi, allowing for the cross-correlation of data.

This means that each PCi has a valid integer from 0 to n−1 for k, and PCk is responsible for the cross-correlation of the kth cycle of partial data Xo(k) for PC0, the kth cycle of partial data X1(k) for PC1, the kth cycle of partial data X2(k) for PC2, . . . , the kth cycle of partial data Xn−2(k) for PCn−2, and the kth cycle of partial data Xn−1(k) for PCn−1. In other words, PCk is responsible for the cross-correlation of partial data Xi(k) stored on the external storage device 18 of PCi 1.

In this manner, for the cross-correlation of the kth cycle of partial data Xi(k) stored on the external storage device 18 of each PCi 1 to occur, the kth cycle of partial data Xi(k) stored on the external storage device 18 of PCi 1 must be arranged to PCk. (See FIG. 3).

This method used to distribute the data is outlined below. Through the switching hub 2, it is possible for each PCi 1 to exchange data with another station as a pair, through a direct connect. Within each pair, the partnered PC transmits any partial data for which its partner is responsible. In this situation, since the cable 3 is a capable of full duplex transmission, the mutual transfer of data can occur simultaneously. In addition, with this process being assisted through the use of the switching hub 2, simultaneous mutual exchanges between each pair of computers of 2 stations can be done. And distribution is completed by changing the combination of the PC's of 2 stations in each pair and repeating this step.

Specific examples of both 4 PC stations and 5 PC stations will be examined. We will begin by explaining a 4 PC stations configuration where n=4. In 4 PC stations configuration with PC0, PC1, PC2, and PC3, the external storage device 18 of each PC contains 4 sections of partial data. Specifically, the external storage device 18 of PC0 contains partial data X0(0), X0(1), X0(2), X0(3), PC1 contains partial data X1(0), X1(1), X1(2), X1(3), PC2 contains partial data X2(0), X2(1), X2(2), X2(3), and PC3 contains partial data X3(0), X3(1), X3(2), X3(3).

The following step entails the data transfer between each pair of PC's. Each pair is inscribed through the use of parentheses.

Step .. (PC0, PC1) (PC2, PC3)

Step .. (PC0, PC3) (PC1, PC2)

Step .. (PC0, PC2) (PC1, PC3)

These steps do not necessarily need to be performed in this order. The order can be switched around according to suitability.

Here, regarding the inclusion of which pair to use in each step, it is recommend avoiding referring to the same computer each time. Also, it is recommended not to keep the combination of paired PCs in a static arrangement for each step. As a means to achieve as many simultaneous data transmissions through the cycle, another step would be to reduce the frequency with which the steps are performed with as much as possible.

To begin, in step, PC0 and PC1, and PC2 and PC3 are connected together via a switching hub 2 where the mutual transmission of data occurs simultaneously. PC0 transmits partial data X0(1) that PC1 is responsible for, while PC1 transmits partial data X1(0) that PC0 is responsible for. PC2 transmits partial data X2(3) that PC3 is responsible for, while PC3 transmits partial data X3(2) that PC2 is responsible for.

In step, PC0 and PC3, and PC1 and PC2 are connected together via a switching hub 2 where the mutual transmission of data occurs simultaneously. PC0 transmits partial data X0(3) that PC3 is responsible for, while PC3 transmits partial data X3(0) that PC0 is responsible for. PC1 transmits partial data X1(2) that PC2 is responsible for, while PC2 transmits partial data X2(1) that PC1 is responsible for.

In step ., PC0 and PC2, and PC1 and PC3 are connected together via a switching hub 2 where the mutual transmission of data occurs simultaneously. PC0 transmits partial data X0(2) that PC2 is responsible for, while PC2 transmits partial data X2(0) that PC0 is responsible for. PC1 transmits partial data X1(3) that PC3 is responsible for, while PC3 transmits partial data X3(1) that PC1 is responsible for.

After all the steps are completed, PC0 has X0(0), X1(0), X1(0), X2(0) and X3(0). PC1 has X0(1), X1(1), X2(1) and X3(1). PC2 has X0(2), X1(2), X2(2) and X3(2). PC3 has X0(3), X1(3), X2(3) and X3(3). Since data transmission methods generally involve sending a copy of the data, each PC 1 still has the original data Xi(j).

We will now explain 5 PC stations configuration where n=5. In 5 PC stations configuration with PC0, PC1, PC2, PC3 and PC4, the external storage device 18 of each PC 1 contains 5 sections of partial data. Specifically, the external storage device 18 of PC0 contains partial data X0(0), X0(1), X0(2), X0(3), X0(4), PC1 contains partial data X1(0), X1(1), X1(2), X1(3), X1(4), PC2 contains partial data X2(0), X2(1), X2(2), X2(3), X2(4), PC3 contains partial data X3(0), X3(1), X3(2), X3(3), X3(4), and PC4 contains partial data X4(0), X4(1), X4(2), X4(3) and X4(4).

The following step entails the data transfer between each pair of PC's. Each pair is inscribed through the use of parentheses.

Step .. (PC0, PC1) (PC2, PC4)

Step .. (PC0, PC2) (PC3, PC4)

Step .. (PC0, PC3) (PC1, PC2)

Step .: (PC0, PC4) (PC1, PC3)

Step .: (PC1, PC4) (PC2, PC3)

These steps do not necessarily need to be performed in this order. The order can be switched around according to suitability.

Here as well, with regards to the inclusion of which pair to use in each step, it is recommend avoiding referring to the same computer each time.

To begin, in step ., PC0 and PC1, and PC2 and PC4 are connected together via a switching hub 2 where the mutual transmission of data occurs simultaneously. PC0 transmits partial data X0(1) that PC1 is responsible for, while PC1 transmits partial data X1(0) that PC0 is responsible for. PC2 transmits partial data X2(4) that PC4 is responsible for, while PC4 transmits partial data X4(2) that PC2 is responsible for.

In step ., PC0 and PC2, and PC3 and PC4 are connected together via a switching hub 2 where the mutual transmission of data occurs simultaneously. PC0 transmits partial data X0(2) that PC2 is responsible for, while PC2 transmits partial data X2(0) that PC0 is responsible for. PC3 transmits partial data X3(4) that PC4 is responsible for, while PC4 transmits partial data X4(3) that PC3 is responsible for.

In step ., PC0 and PC3, and PC1 and PC2 are connected together via a switching hub 2 where the mutual transmission of data occurs simultaneously. PC0 transmits partial data X0(3) that PC3 is responsible for, while PC3 transmits partial data X3(0) that PC0 is responsible for. PC1 transmits partial data X1(2) that PC2 is responsible for, while PC2 transmits partial data X2(1) that PC1 is responsible for.

In step ., PC0 and PC4, and PC1 and PC3 are connected together via a switching hub 2 where the mutual transmission of data occurs simultaneously. PC0 transmits partial data X0(4) that PC4 is responsible for, while PC4 transmits partial data X4(0) that PC0 is responsible for. PC1 transmits partial data X1(3) that PC3 is responsible for, while PC3 transmits partial data X3(1) that PC1 is responsible for.

In step ., PC1 and PC4, and PC2 and PC3 are connected together via a switching hub 2 where the mutual transmission of data occurs simultaneously. PC1 transmits partial data X1(4) that PC4 is responsible for, while PC4 transmits partial data X4(1) that PC1 is responsible for. PC2 transmits partial data X2(3) that PC3 is responsible for, while PC3 transmits partial data X3(2) that PC2 is responsible for.

After all the steps are completed, PC0 has X0(0), X1(0), X2(0), X3(0) and X4(0). PC1 has X0(1), X1(1), X2(1), X3(1) and X4(1). PC2 has X0(2), X1(2), X2(2), X3(2) and X4(2). PC3 has X0(3), X1(3), X2(3), X3(3) and X4(3). PC4 has X0(4), X1(4), X2(4), X3(4) and X4(4). Since data transmission methods generally involve sending a copy of the data, each PC 1 still has the original data Xi(j).

As an example we have shown possible configurations for when n=4 or n=5. However, when using n stations in general, the PC pair should be different in each step and the same step should not use the same combination pair. If these rules are followed then we will be able to determine how many steps it will take to finish transmitting the data if you take 2 from n.
If n is equal to an even number, and since

$$\frac{{}_{n}^{}{C}{}_{2}^{}}{\frac{n}{2}} = \frac{n ( n - 1 )}{2} \cdot \frac{2}{n} = n - 1$$

then n−1 steps will be required to finish distributing the data. If n is equal to an odd number, and since

$$\frac{{}_{n}^{}{C}{}_{2}^{}}{\frac{n - 1}{2}} = \frac{n ( n - 1 )}{2} \cdot \frac{2}{n - 1} = n$$

then n steps will be required to finish distributing the data.

In this manner, it is theoretically able to determine the number of steps required to finish distributing the data in the case of n stations. However, there is a concrete relationship between each step pair and each PC pair. Therefore, it follows that the method employed by this invention can be applied to any number of PCs. It will be shown how to solve for each step pair and PC pair for n number of stations later on.

Above we have explained how each data Xi is divided by n. We will now explain how data Xi can be divided into more than n of partial data Xi(m) as size of unit data. Since the PC and network configurations do not change, we will explain how to devide data Xi and how to transmit the devided data.

The size of the unit data is thought, for example, to be q-bit, and each data Xi is thought to be able to divide into partial data of n times and more.

Specifically, for each data Xi, given that X0 can be divided into q-bit partial data X0(0), X0(1), X0(2), . . . greater than n, X1 can be divided into q-bit partial data X1(0), X1(1), X1(2), . . . greater than n and this holds true for any value of Xi which can be divided into q-bit partial data Xi(0), Xi(1), Xi(2), . . . greater than n. data. In other words, given that data Xi in PCi is partitioned into partial data Xi(m) (where m is an integer 0 and more), and that m is an integer greater than n−1, it follows that for any value of m, the size of data Xi(m) is q-bit.

Although we employ the term “divisible”, just as previously mentioned, “divisible” to this invention includes the case that consecutive data Xi is devided into partial data Xi(m), and the case that data Xi are the aggregate of the partial data Xi(m).

There is no requirement that size of each unit of partial data Xi(j) must match the others. However, for the most part it is ideal if they do. An example would be if the size of each partial data Xi(m) is equal to the transmission speed of the network cable 3.

Next, as described above, partial data from each PCi is formed into blocks comprising of n units of consecutive partial data without overlapping. Specifically, partial data X0(0), X0(1), X0(2) . . . greater than n from PC0 is formed into block 0 which includes partial data X0(0), X0(1), X0(2), . . . , X0(n−2), X0(n−1), block 1 which includes partial data X0(n), X0(n+1), . . . , X0(2n−2), X0(2n−1), and similarly block a (where α is an integer greater than 0) which includes partial data X0(n×α), X0(n×α+1), . . . , X0(n×α+n−2), X0(n×α+n−1).

Data from other PCs are handled in the same fashion. Partial data greater than n are formed into blocks. Partial data Xi(0), Xi(1), . . . , Xi(n−2), Xi(n−1) is formed into block 0, partial data Xi(n), Xi(n+1), . . . , Xi(2n−2), Xi(2n−1) is formed into block 1, and this continues for every instance of a. Partial data Xi(n×α), Xi(n×a+1), . . . , Xi(n×a+n−2), Xi(n×a+n−1) are formed into block a.

It is not necessary to form the blocks mentioned above. it is blocked without overlapping in n units of every consecutive partial data. For example, block 0 would be Xi(0), Xi(1), block 1 would be Xi(2)˜Xi(n+1), block 2 would be Xi(n+2)˜Xi(2n+1). If this method is used, the units of partial data in block 0 would not be greater than n, rather it would be 2. This is due to the same reasons presented above for the formation of blocks. In other words, in the formation of blocks mentioned above, block α of PCi is comprised of partial data Xi(n×α), Xi(n×α+1), . . . , Xi(n×α+n−2), Xi(n×α+n−1). However, the final block will not always have n units of partial data. This type of data distribution is examined later in the section <The case where the units of partial data are less than n>.

Each PCi is responsible for the cross-correlation of the partial data residing in the blocks discussed above. Specifically, PC0 is responsible for the cross-correlation of data residing in partial data X0(0), X1(0), . . . , Xn−2(0), Xn−1(0) of block 0, partial data X0(n), X1(n), . . . , Xn−2(n), Xn−1(n) of block 1, and partial data X0(2n), X1(2n), Xn−2(2n), Xn−1(2n) of block 2. Furthermore, PC1 is responsible for the cross-correlation of data residing in partial data X0(1), X1(1), . . . , Xn−2(1), Xn−1(1) of block 0, partial data X0(n+1), X1(n+1), . . . , Xn−2(n+1), Xn−1(n+1) of block 1, and partial data X0(2n+1), X1(2n+1), . . . , Xn−2(2n+1), Xn−1(2n+1) of block 2. Data from other PCs are treated accordingly where PCk is responsible for the cross-correlation of data residing in partial data X0(k), X1(k), . . . , Xn−2(k), Xn−1(k) of block 0, partial data X0(n+k), X1(n+k), . . . , Xn−2(n+k), Xn−1(n+k) of block 1, and partial data X0(2n+k), X1(2n+k), . . . , Xn−2(2n+k), Xn−1(2n+k) of block 2. In other words, PCk is responsible for the cross-correlation of partial data Xi(k+n×α) residing in each PCi. Block α is also included in this partial data Xi(k+n×α).

In this manner, for the cross-correlation of the kth cycle of partial data . . . ×α. stored on the external storage device 18 of each PCi to occur, the(k+n×α) cycle of partial data Xi . . . ×α.stored on the external storage device 18 of PCi must arranged to the kth of PCk. (See FIG. 4).

Since each block in this method of data distribution includes n units of consecutive partial data, n division can be used to explain each block. In other words, between each PCi, data is arranged in each block as Xi(O)˜Xi(n−1), Xi(n)−Xi(2n−1), Xi(2n)−Xi(3n−1). (As for particular specifics, n division can be used to examine each block.)

<The Case Where the Units of Partial Data are Less Than n>

As previously mentioned, there are cases where the number of units in a block's partial data is less than n. In this case, the method of arranging the block's data is as shown with an actual example below. If required, the number of units of partial data can be set in the same way as when the number of articles is n, but here, in a case where n=4, we will explain where the number of partial data units in block 0 is equal to 2.

The arrangement of partial data in block 0 of each PC prior to distribution of the data is as shown below.

..0..0....0...

..1..1....1...

..2..2....2...

..3..3....3...

In the case where n=4, the steps, as previously mentioned, are,

Step .:...0....1...2...3

Step ....0...3...1...2.

Step ....0...2...1...3.

Accordingly, if we follow these steps, at step ., in pair (PC0, PC1), the X0 of PC0 (1) and the X1 of PC1 (0), will transfer data to each other, and in pair (PC2, PC3), nothing will be done. In step ., at pair (PC0, PC3), X3 (0) will be transferred from PC3 to PC0, and at pair (PC1, PC2), X2(1) will be transferred from PC2 to PC1. In step ., at pair (PC1, PC3), X3(1) will be transferred from PC3 to PC1.

If this step is repeated in the same way, in a case where there is no partial data in the parter PC of a PC pair, data transfer should be carried out from only one side, like a half duplex transmission.

In this manner, data is divided into units of partial data as a size of unit data greater than n. Furthermore, depending how partial data is used to form the blocks, for example, when VLBI observation is carried out, and while consecutively collecting and storing data, data that has already been stored in an external storage device 18, will be divided into partial data. Because the data of every block are able to be arranged to each PC properly, the cross correlation operation of the data which have already been collected is decided to be done at the same time with the observation.

<Method of Combining Computer Pairs>

As shown in equation 1 and equation 2, in the case of n stations, the number of steps that are theoretically required to complete the data transfer is found. However, how to actually combine the pairs for each step becomes the problem. An example for a case where n=6, will be shown. In the case where n=6, take the following pairs as the combination of pairs used for the first three steps.
Step .:...0...1...2...3...4...5.
Step .:...5...5...2...3...4.
Step .:...0...3...4...2...5.

In this case, for each pair at each step, we try not to include the same PC. Under the condition that at each step pairs containing combinations of the same pair, when we think of combinations of pairs for the continuing steps, as an example, at least the following three steps will be necessary.
Step .:...0...4...1...3.
Step .:...1...1...5.
Step .:...2...4...3...5.

In other words, as shown in equation 1, in the case of n=2, although it seems to require 5 steps to completion, because of the combination of pairs at each step and pair PCs, 6 steps are actually needed. As the number of steps increases, the time taken for data arrangement also increases, and it is not efficient. This is due to the arbitrary combining of pairs at each step and pair PCs. The arrangement of data cannot be completed in the theoretical number of steps, and shows that efficient arrangement of data cannot be carried out.

Therefore, for n-stations, we will now explain the search for an actual method of the combination of pairs at each step and pair PCs. This will enable us to carry out the data arrangement in the theoretically most efficient number of steps.

Because a situation where n-number of stations being equal to 2 is obvious, let us examine an n-number of stations greater than 3. First, if n is an odd number, we take a circle and mark n points on the circumference of the circle (as though we were making an equilateral shape of n sides). Moving around the circle, for example, ih the crockwise direction, we number these points from 0 to n−1. These points around the circle correspond to PCi. In other words, if n is an odd number, getting the combination of pairs at each step and pair PCs to cycle through each step n times (this times is clear according to equation 2) would require diagonal lines being drawn from in between the intervals surrounding the circumference from one line on one interval to a point without multiple diagonal lines such as (n−1). To put it another way, processing diagonal lines from many points during 1 cycle of the step, under the condition that multiple diagonal lines must not be drawn from each point and by repeating this process n times, overlap diagonal lines from between the points around the circumference will be removed. This method will result in the drawing of a diamond pattern.

First, in step 1 (Though the number of the step showed it with a circle number in the above, it is shown with a mere number in the following in reason of the indication), in (n−1) points except for the point marked 0, a straight line is drawn from the point marked 0, through the centre of the circle. A pair is made from the two points symmetrically opposed to this line. The pairs made by this action (n−1)/2, are the pairs for step 1, and this will then be the actual pairing of PCs. To give a concrete example, in the case where n=7, the actual PC pairings are .PC1, PC6.PC2, PC5.PC3, PC4.

Next, in step 2, in (n−1) points except for the point marked 1, a straight line from the point marked 1 is drawn through the centre of the circle. A pair is made from the two points symmetrically opposed to this line. The pairs made by this action (n−1)/2, are the pairs for step 2, and this will then be the actual pairing of PCs. To give a concrete example, in the case where n=7, the actual PC pairings are .PC2, PC0.PC3, PC6.PC4, PC5.

As shown in the following, we can find the actual combination of PCs to get the pair combinations for each step. Namely, at step R (where R is a natural number), in (n−1) points except for the point marked R−1, a straight line from the point marked R−1 is drawn through the centre of the circle. A pair is made from the two points symmetrically opposed to this line. The pairs made by this action (n−1)/2, are the pairs for step R, and this each pair will then be the actual pairing of PCs. A straight line is drawn through the centre of the circle from the point marked R−1, and if this is carried out from each of n-points, the total number of steps will be n.

Next, in the case of an even number, we should think about the sum set of PCs of (n−1) stations and the PC of 1 staition. To put it in other words, in the case where n is an even number, we should think that the one point is to be connected by a line to the PC of 1 station that is outside the circle. (Bcause the actual arrangement of the PCs increases by one, the amount of pairs at each step will be ..-.-..........). Because of this, in total the number of steps will be n−1.

In the above manner, the actual arrangement of PCs that will provide the pair combinations at each step is found. Of course, there is no rule saying the steps must be in this order, and they can be changed. Also, we are not stating that the method used to get the combination of PCs that provides the steps shown here is the only one thinkable. However, if the method shown in this appendix is used, no matter what the number of PC stations used are, a pair combination that will make possible the arrangement of data in the theoretical efficient number of steps will be easily obtained every time, and it is useful when the number of PC staition are especially big.

<When Using a Full Duplex Transmission Capable Line Concentrator>

A situation where multiple PCs are connected to a switching hub 2 via network cables 3 is explained above. By using a full duplex transmission capable line concentrator with a switching hub 2, all of the computers will be able to exchange data simultaneously. Therefore, regardless whether the number of PC stations (n) are even or odd, a highly efficient transfer of data will be attained.

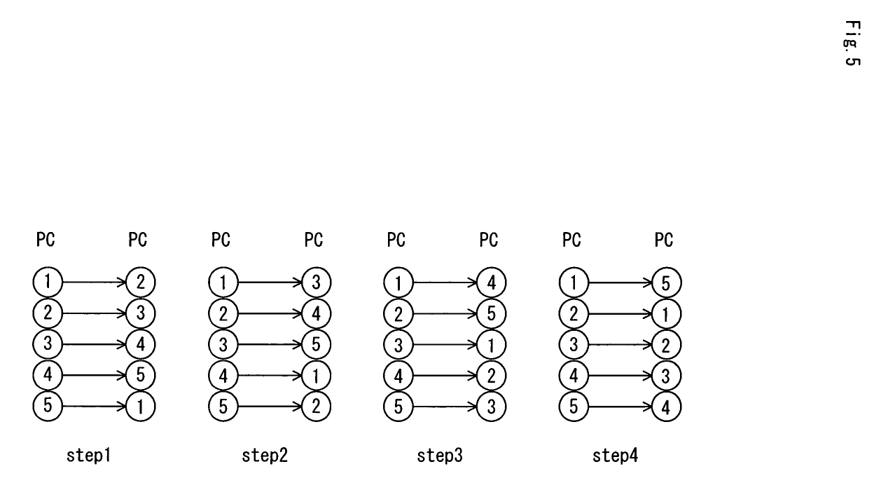

FIG. 5 shows the processing steps that will carry out data transfer where n=5, the number of PC stations are odd, and full duplex transmission capable line concentrator is used. As mentioned previously, the data is recorded to the external storage devices 18 of PC0, PC1, PC2, PC3, PC4, and divided into 5 units of the partil data. Namely, the data is stored in the following way. In the external storage devices 18 of PC0, the partial data X0(0), X0(1), X0(2), X0(3), X0(4) are stored. In the external storage devices 18 of PC1, the partial data X1(0), X1(1), X1(2), X1(3), X1(4) is stored. In the external storage devices 18 of PC2, the partial data X2(0), X2(1), X2(2), X2(3), X2(4) is stored. In the external storage devices 18 of PC3, the partial data X3(0), X3(1), X3(2), X3(3), X3(4) is stored. In the external storage devices 18 of PC4, the partial data X4(0), X4(1), X4(2), X4(3), X4(4) is stored.

Between the PC for sending data and the PC for receiving data, the steps to send the partial data controlled by the PC are repeated as mentioned before. Data transfer is carried out following each step as shown in the drawing.
Step 1:..i->..i+1
Step 2:..i->..i+2
Step 3:..i->..i+3
Step 4:..i->..i+4
   This is not an order that must be followed, but can be changed to suit. i is the number which shows the number of the staition of PC's, and it is an integer from 1 to 4. When (i+1), etc. exceeds 4, it is returned in the value i that 4 was reduced, and an index is done. This is not limited only to cases where the number of n-PC stations=5, but is the same for all cases where n is an odd number.

In this way, even when n number of PC stations is an odd number, by repeating the step n−1 times, we can carry out the function quickly and efficiently.

With the invention of this data distribution method and device, the data that is subject to cross correlation and stored in the external storage devices of multiple computing stations, is divided into partial data and efficiently arranged at each computer. Therefore, even when the data being processed is of an extremely large scale, for example the time siries data obtained by VLBI observation using a radio telescope, distributed processing of cross correlation using cheaper personal computers instead of the more expensive specialized computers is possible. Also, sending time at each step is not dependent on n-number of stations, and as shown equation 1 and equation 2, the total number of steps required will be n or n−1.

Furthermore, data is divided into more than n partial data of a size of data units, and continuing from that block division is carried out without overlapping. Data arrangement is carried out block by block. Whilst still carrying out the arrangement of data, the arrangement of data that has already been collected to each station becomes possible. Put side by side with data collection, data that has already been collected can now be cross correlated.

Of special note, since the network medium or line concentrator are capable of full duplex transmissions, the number of steps taken can be cut to n−1, regardless of whether or not n is an odd number. This will then reduce the processing time needed for arrenging the data.

1. In the network system that n (n is any real number of 2) number of computers PCi, (integer i represents the number of PCi from 0 to n−1) are connected to a line concentrator or communications network that has a switching function, the data distribution method is characterized in that
each computer PCi has a storage device that is responsible for storing data Xi (i is an integer from 0 to n−1) that is to be cross correlated, the data Xi noted above on each PCi can be divided into n partial data Xi(j) (j is an integer from 0 to n−1), computer PCk (k is an integer from 0 to n−1) is responsible for the cross correlation processing of partial data Xi(k) located on each computer PCi and further, in each pair including 2 computers which are connected to be able transmit data via the line concentrator or communications network noted above, mutually between 2 computers which are connected, the computer repeats steps that computers transmit their allocated partial data to the partner computer which is connected to said computer between each other.

2. The data distribution method according to claim 1 wherein said step is repeated n−1 times if n is even and n times when if n is odd, and each cycle of the step is repeated only between said pair of computers and a same pair of computers is allocated without overlapping through all of the steps.

3. In the network system that n (n is any real number of 2) number of computers PCi, (integer i represents the number of PCi from 0 to n−1) are connected to a line concentrator or communications network capable of full duplex transmission with switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(j) (j is an integer from 0 to n−1), computer PCk (k is an integer from 0 to n−1) is responsible for the cross correlation processing of partial data Xi(k) located on each computer PCi, and further, in computers which are connected to be able transmit data via the line concentrator or communications network noted above, in repeating the step that computers transmit their allocated partial data between the computer which sends data and the computer which receives data, during each step, same computer for sending and same computer for receiving are allocated without overlapping and same computers are allocated without overlapping through all of the steps, and these steps are repeated n−1 times, regardless of whether n being even or odd.

4. In the network system that n (n is any real number of 2) number of computers PCi, (integer i represents the number of PCi from 0 to n−1) are connected to a line concentrator or communications network that has a switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(m) (m is an integer from 0 to n−1) having a size of unit data and can be divided into the block of every consecutive n of the partial data without overlapping, computer PCk (k is an integer from 0 to n−1) is responsible for the cross correlation processing of partial data Xi(k) located on each computer PCi, and further, in each pair including 2 computers which are connected to be able transmit data via the line concentrator or communications network noted above, mutually between 2 computers which are connected, the computer repeats steps that computers transmit their allocated partial data to the partner computer which is connected to said computer between each other.

5. The data distribution method according to claim 4 wherein the block of the . turn (where . is an integer of 0 and more) includes partial data from n×. to (n×.+n−1) and the computer PCk of the k turn is responsible for the cross correlation processing of partial data Xi(k+n×.) located on each computer PCi.

6. The data distribution method according to claim 4 or 5 wherein said steps are applied to every block n−1 times if n is an even number, and n times if n is an odd number and each cycle of the step are repeated between the said pairs of computers assigned without overlapping, and all of the steps are repeated between said pairs assigned without overlapping.

7. In the network system that n (n is any real number of 2) number of computers PCi, (integer i represents the number of PCi from 0 to n−1) are connected to a line concentrator or communications network capable of full duplex transmission with switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(m) (m is an integer from 0 to n−1) having a size of unit data and can be divided into the block of every consecutive n of the partial data without overlapping, computer PCk (k is an integer from 0 to n−1) is responsible for the cross correlation processing of partial data Xi(k) located on each computer PCi, and further, in computers which are connected to be able transmit data via the line concentrator or communications network noted above, in repeating the step that computers transmit their allocated partial data between the computer which sends data and the computer which receives data, during each step, same computer for sending and same computer for receiving are allocated without overlapping and same computers are allocated without overlapping through all of the steps, and these steps are repeated n−1 times, regardless of whether n being even or odd,

8. The data distribution method according to one of claims 1 to 7 that computers used in this method are general purpose computers.

9. The data distribution method according to one of claims 1 to 8 that the network medium allows for full duplex communications.

10. The data distribution method according to one of claims 1 to 9 that data used in this method are time series data recorded from radio telescopes.

11. In the network system that n (n is any real number of 2) number of computers PCi, (integer i represents the number of PCi from 0 to n−1) are connected to a line concentrator or communications network that has a switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(j) (j is an integer from 0 to n−1), computer PCk (k is an integer from 0 to n−1) is responsible for the cross correlation processing of partial data Xi(k) located on each computer PCi and further, in each pair including 2 computers which are connected to be able to transmit data via the line concentrator or communications network noted above, mutually between 2 computers which are connected, includes data transmission means which repeats steps that computers transmit their allocated partial data to the partner computer which is connected to said computer between each other.

12. In the network system that n (n is any real number of 2) number of computers PCi, (integer i represents the number of PCi from 0 to n−1) are connected to a line concentrator or communications network that has a switching function, the data distribution method is characterized in that
each computer PCi has a storage device that is responsible for storing data Xi (i is an integer from 0 to n−1) that is to be cross correlated, the data Xi noted above on each PCi can be divided into n partial data Xi(m) (m is an integer from 0 to n−1) having a size of unit data and can be divided into the block of every consecutive n of the partial data without overlapping, computer PCk (k is an integer from 0 to n−1) is responsible for the cross correlation processing of partial data Xi(k) located on each computer PCi, and further, in each pair including 2 computers which are connected to be able transmit data via the line concentrator or communications network noted above, mutually between 2 computers which are connected, includes data transmission means which repeats steps that computers transmit their allocated partial data to the partner computer which is connected to said computer between each other.

13. In the network system that n (n is any real number of 2) number of computers PCi, (integer i represents the number of PCi from 0 to n−1) are connected to a line concentrator or communications network capable of full duplex transmission with switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(j) (j is an integer from 0 to n−1), computer PCk (k is an integer from 0 to n−1) is responsible for the cross correlation processing of partial data Xi(k) located on each computer PCi, and further, in computers which are connected to be able transmit data via the line concentrator or communications network noted above, in repeating the step that computers transmit their allocated partial data between the computer which sends data and the computer which receives data, during each step, same computer for sending and same computer for receiving are allocated without overlapping and same computers are allocated without overlapping through all of the steps, and includes data transmission means in which these steps are repeated n−1 times, regardless of whether n being even or odd.

14. In the network system that n (n is any real number of 2) number of computers PCi, (integer i represents the number of PCi from 0 to n−1) are connected to a line concentrator or communications network capable of full duplex transmission with switching function, the data distribution method is characterized in that each computer PCi has a storage device that is responsible for storing data Xi (i is an integer from 0 to n−1) that is to be cross correlated, the data Xi noted above on each PCi can be divided into n partial data Xi(m) (m is an integer from 0 to n−1) having a size of unit data and can be divided into the block of every consecutive n of the partial data without overlapping, computer PCk (k is an integer from 0 to n−1) is responsible for the cross correlation processing of partial data Xi(k) located on each computer PCi, and further, in computers which are connected to be able transmit data via the line concentrator or communications network noted above, in repeating the step that computers transmit their allocated partial data between the computer which sends data and the computer which receives data, during each step, same computer for sending and same computer for receiving are allocated without overlapping and same computers are allocated without overlapping through all of the steps, and data transmission means in which these steps are repeated n−1 times, regardless of whether n being even or odd.

15. The data distribution method according to one of claims 11 to 14 that the network medium allows for full duplex communications.
